(19) United States
(12) Patent Application Publication
(10) Pub. No.: US 2018/0106686 A1
(43) Pub. Date: Apr. 19, 2018

(54) Temperature Sensing and Control of Resistive Heating Elements

(71) Applicant: Infineon Technologies Austria AG, Villach (AT)

(72) Inventors: Wolfgang Furtner, Fuerstenfeldbruck (DE); Christoph Glacer, Muenchen (DE)

(21) Appl. No.: 15/292,997

(22) Filed: Oct. 13, 2016

(51) Int. Cl. G01K 7/16; H05B 1/02

(52) U.S. Cl. CPC G01K 7/16; H05B 1/023

(57) ABSTRACT

A method for temperature sensing and control of resistive heating elements includes providing a power signal to a heater, the power signal having pulse width modulated (PWM) power pulses, providing a measurement pulse to the heater, with the measurement pulse being between two PWM power pulses, measuring a voltage across the heater, and determining a resistance of the heater according to the voltage across the heater and a current of the measurement pulse. A temperature of the heater is determined according to the determined resistance of the heater.

### TECHNICAL FIELD

The present invention relates generally to a system and method temperature sensing and control or resistive heating elements, and, in particular embodiments, to a system and method for sensing a temperature of a heating element by direct measurement of the heating element properties.

### BACKGROUND

In some applications, and particularly in miniaturized sensors such as gas or humidity sensors, resistive heating elements with precise temperature control are used to heat a sensor element to the sensor element's most efficient operating temperature. Energy is supplied to the heating element by attaching it to a defined supply voltage. The energy transferred to the heater is controlled in order to set a certain temperature, and a feedback mechanism is used to sense the temperature and adjust the power supplied to the heating element. For energy efficiency reasons, pulse width modulated (PWM) control is used to control the power delivered to a heating element. In some applications, a linear mode control may instead be used to control the current or power delivered to the heating element.

### SUMMARY

In accordance with a preferred embodiment of the present invention, a method for temperature sensing and control of resistive heating elements includes providing a power signal to a heater, the power signal having pulse width modulated (PWM) power pulses, providing a measurement pulse to the heater, with the measurement pulse being between two PWM power pulses, measuring a voltage across the heater, and determining a resistance of the heater according to the voltage across the heater and a current of the measurement pulse. A temperature of the heater is determined according to the determined resistance of the heater.

An embodiment device includes a signal switching circuit connected to the one or more heater ports, and the heater ports are configured to be connected, respectively, to one or more heaters. The device further includes a current source connected to the signal switching circuit, with the signal switching circuit disposed between the current source and the one or more heater ports. A control circuit is coupled to the signal switching circuit, and a voltage measurement circuit is configured to measure a first voltage across the one or more heater ports. The signal switching circuit is configured to control a first current from the current source to provide a measurement pulse to the one or more heater ports according to a second signal from the control circuit. The first voltage is created by the measurement pulse across the one or more heater ports, and the control circuit is configured to control the signal switching circuit according to a temperature determined according to the measured first voltage.

An embodiment device includes a first heater, a first measurement switch having a first end connected to a first end of the first heater, a current source having a first end connected to a second end of the first measurement switch, a control circuit connected to the first measurement switch, and an analog to digital converter (ADC) having a first analog input end connected to the first end of the first heater and a digital output end connected to the control circuit.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a graph illustrating a temperature induced change of a heater element according to a duty cycle of a power signal;

FIG. 2 is a block diagram illustrating a sensor system having temperature sensing and control according to some embodiments;

FIG. 3 is a circuit diagram illustrating a temperature sensing and control system according using a controlled measurement current according to some embodiments;

FIGS. 4A and 4B are graphs illustrating operating properties for a temperature sensing and control system using a controlled measurement current according to some embodiments;

FIG. 5 is a circuit diagram illustrating a temperature sensing and control system with multiple heaters according to some embodiments;

FIG. 6 is a graph illustrating operating properties for a temperature sensing and control system with multiple heaters according to some embodiments;

FIG. 7 is a circuit diagram illustrating a temperature sensing and control system with multiple heaters according to some embodiments;

FIG. 8 is a graph illustrating operating properties for a temperature sensing and control system with multiple heaters according to some embodiments;

FIG. 9 is a circuit diagram illustrating a temperature sensing and control system with multiple heaters according to some embodiments; and

FIG. 10 is a flow diagram illustrating a method for temperature sensing and control according to some embodiments.

### DETAILED DESCRIPTION OF ILLUSTRATIVE EMBODIMENTS

The making and using of embodiments are discussed in detail below. It should be appreciated, however, that the present invention provides many applicable inventive concepts that may be embodied in a wide variety of specific contexts. The specific embodiments discussed are merely illustrative of specific ways to make and use the invention, and do not limit the scope of the invention.

In order for the sensors to work most efficiently and accurately, the sensor is ideally heated to a precise and repeatable preset temperature by a heater element. For example, a gas sensor may be specified to work at a particular temperature, and for consistency, the target temperature may be set well above ambient since heating the sensor is more simple than cooling the sensor. The different resistances of the heating element at different temperatures may be used to determine the temperature of the heating element. The heating element itself can therefore be used as a temperature sensor. Sensing the temperature of the heating element allows the power delivered to the heating element to be adjusted so that the heating element achieves and maintains an accurate predetermined temperature, which increases the accuracy of the related sensor. The disclosed embodiments of the heating sensing and control system provide pulse width controlled heating of one or more heating elements while at the same time sensing their temperature using the resistance of the heating element.

The temperature of the heater may, in some embodiments, be controlled by adjusting the PWM duty cycle. A duty cycle is the ratio of the time a power source is “on”, or supplying power to a heater, to the total length of time between pulses, or the pulse frequency. For example, the duty cycle D may be calculated according to equation 1:

D=t_on/(t_on+t_off) (1)

In equation 1, t_on is the time in a cycle that the power is on, and t_off the time in the cycle that the power is off.

A system for controlling one or more heating elements and providing accurate temperature sensing with minimal disruption to the heating cycle includes, in some embodiments, a measurement current is passed through the heater between, or in place of power pulses of the PWM signal. A voltage induced by the measurement current is measured across the heater, and the resistance determined from the measured current. The temperature of the heater can then be determined from the resistance. The determined temperature may then be used by a control circuit to adjust the duty cycle to raise or lower the temperature of the heater to the desire range. The heater resistance is measured by applying a known reference current during periods when the heater supply voltage is not connected to the heater, for example, between PWM power signal pulses. The measured resistance is then used to determine the heater temperature. Additionally, for system with multiple heater channels the same known reference current for all heating elements in a time multiplexed fashion, reducing the number of current sources required to individually measure each heater resistance. Some embodiments have multiple heater channels and a switch topology that reduces the number of overall switches required.

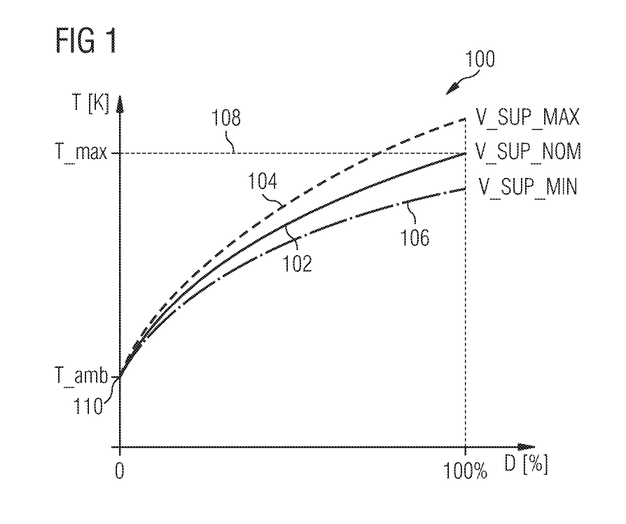

FIG. 1 is a graph illustrating a temperature induced change of a heater element according to a duty cycle of a power signal Temperature is typically a non-linear function of the duty cycle, since the resistance of the heater changes with temperature, and this influences the amount of energy transferred to the heater. At a known supply voltage V_SUP 102, the temperature of the heater rises according to the duty cycle until the temperature reaches a target or maximum temperature T_max 108. The temperature curves of the resistor will vary depending on the material of the resistor, and the material's temperature coefficient. Additionally, other environmental influences such as convective cooling, cold air, and/or humid air will influence the temperature behavior of the resistor.

In some embodiment materials, the resistance of the materials varies with temperature, as shown in equation 2:

R(T)=R(T0)(1+α(T−T0)) (Eq. 2)

When calculating the resistance at a certain temperature of the heater, α is the temperature coefficient of the material, and R(T0) is the resistance at a certain reference temperature T0. It should be understood that equation 2 may be expanded using, for example, quadratic or higher order terms, and the expansion may be useful in high temperature applications. For a measured heater resistance R(T), the equation allows determination of the temperature of the heater according to equation 3:

T=T0+(R(T)−R(T0))/αR(T0) (Eq. 3)

T is the temperature of the heater element and R(T) is the measured heater resistance at a particular temperature.

The measurement of the heater resistance can be performed using a reference resistor in series with the heater resistance. In this case the voltage drop V_REF over the reference resistor R_REF is measured and the voltage drop over the heater V_HEAT can be determined The following equation can be employed to calculate the heater resistance R_HEAT:

R_HEAT=R_REF*(V_HEAT/V_REF) (Eq. 4)

Knowing the heater resistance, the heater temperature can be calculated with Equation 3.

The heater resistance itself can be used to sense temperature if the resistance of the heater material has a known temperature dependent behavior. In this case, no additional sensors are required to detect the heater temperature. The heater temperature varies with variations or inaccuracies in the supply voltage. Thus, for example at V_SUP_MIN 106 and V_SUP_MAX 104, which are voltages that deviate from the nominal voltage V_SUP_NOM 102, the temperature varies from the target temperature T_max 108. This is because an increased or decreased voltage at a particular duty cycle would result in a temperature that was higher or lower, respectively, than intended. The use of a temperature feedback and sensing system avoids the needs for a precision supply voltage by actively compensating for variations in the supply voltage. Additionally, using a temperature sensing and feedback system allows for correction variations in heater temperature due to varying ambient temperature T_amb 110 and long term drift behavior due to thermal conduction of the heater to its surroundings. False temperature measurements due to heater cold resistance changing due to degradation and aging effects of a constant voltage setup may also be avoided using a direct temperature measurement at the heater element, by recalibration at a known temperature while in a cold state.

Providing feedback through accurate temperature sensing permits the control circuit to adjust the duty cycle of a power signal to arrive at a target temperature. Measuring the temperature directly from the heater element avoids issues that arise from measuring a voltage across a reference resistor in series with the heater element. The use of a reference resistor requires that the reference resistor be calibrated so that an accurate current through the heater element can be determined. Additionally, with a reference resistor, two voltage measurements are required, with one voltage measurement being a differential measurement, multiplying any inaccuracies in the voltage measurements. When multiple heater channels are employed and the current through the heater elements is measured using a reference resistor, a reference resistor is required for each heater channel in order to measure the current through each heater element.

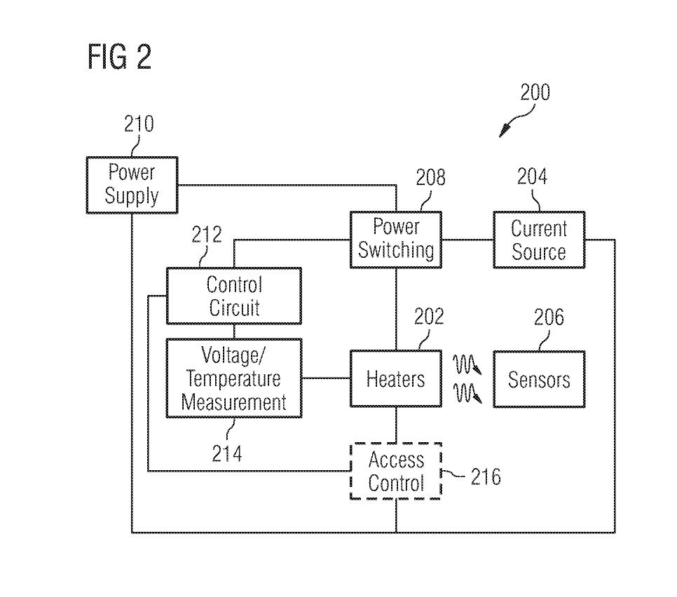

FIG. 2 is a block diagram illustrating a sensor system 200 having temperature sensing and control according to some embodiments. One or more heaters 202 are disposed in the sensor system 200 and heat one or more sensors 206. In some embodiments, the heaters 202 may be formed from tungsten, platinum, polysilicon, or another material with a determined temperature coefficient. A power supply 210 provides a voltage to the heaters 202, and the voltage is controlled by a signal switching circuit that, in some embodiments, includes a power switching circuit 208, according to a determined duty cycle to provide the power needed by the heaters 202 to reach the target temperature. The power switching circuit 208 is controlled by a control circuit 212 that determines the temperature of the heaters 202 and adjusts the duty cycle of the voltage signal powering the heaters 202. A voltage measurement circuit 214 circuit measure a voltage across the heaters 202 and provides a temperature signal to the control circuit 212 indicating the temperature of the heaters. In some embodiments, the temperature signal is a signal representing an analog voltage, or may be a digital signal that is converted from, for example, an analog voltage by an analog-to-digital converter (ADC). In other embodiments, the temperature signal may be a digital signal indicating the temperature that is generated by the voltage measurement circuit 214 converting a voltage across the heaters 202 to a temperature.

The power switching circuit 208 also switches the signal being provided to the heaters 202 between the power signal from the power supply and a measurement signal from a current source 204. The measurement signal may be a constant current signal while the power signal may be a constant voltage signal. Using a dedicated current source 204 provides the ability to accurately control the current of the measurement signal without requiring that the power supply 210 provide a precisely controlled signal. Thus, the power supply 210 may provide a higher power signal that is less accurate or precise than the measurement signal from the current source 204. The voltage measurement circuit, for example, may be an ASIC with a measurement range of 0 to 1 volts, or 0 to 5 volts, and may require a smaller voltage than that provided by the power supply 210.

In some embodiments, the control circuit 212 controls the power switching circuit 208 to coordinate the signals from the power supply 210 and the current source 204. The measurement signal from the current source 204 is supplied to the heaters 202 between pulses of the power signal, or in place of one or more pulses from the power signal.

In some embodiments, the signal switching circuit includes an address control circuit 216 that is controlled by the control circuit 212 to address individual heaters when multiple heaters are disposed in the sensor system 200. Thus, a single current source 204 may be used to provide the measurement signal to a single heater in a group of heaters 202.

In an embodiment, the control circuit 212 has a feedback circuit that adjusts the duty cycle of the signal from the power supply through, for example, a PWM controller. The feedback circuit may, for example, be a control loop feedback mechanism such as a proportional-integral-derivative (PID) loop filter. The temperature of the heater is sensed and compared to the target temperature. The temperature difference filtered by a PID loop filter controls the duty cycle of the PWM controller. The PWM controller provides a control signal to the power switching circuit 208 the turn on or off the voltage being provided by the power supply 210 to the heaters 202. The filter may be chosen such that the heater temperature will stably reach the target temperature in a short amount of time and regardless of the ambient temperature. Thus, the filter will adjust to varying ambient temperature and also track changes of the target temperature.

In some embodiment, the voltage measurement circuit 214 and control circuit 212 are integrated elements formed, in for example, an application specific integrated circuit (ASIC) with the power switching circuit 208, and may be on separate dies or circuits from the heaters 202 and sensors 206, or may be packaged together in a system in package (SIP) with the heaters 202 and sensors 206. In other embodiments, the voltage measurement circuit 214 or control circuit 212 may be formed from discrete components, separate components such as a dedicated die or ASIC, or may be formed on a package, die, or chip separate from the heaters.

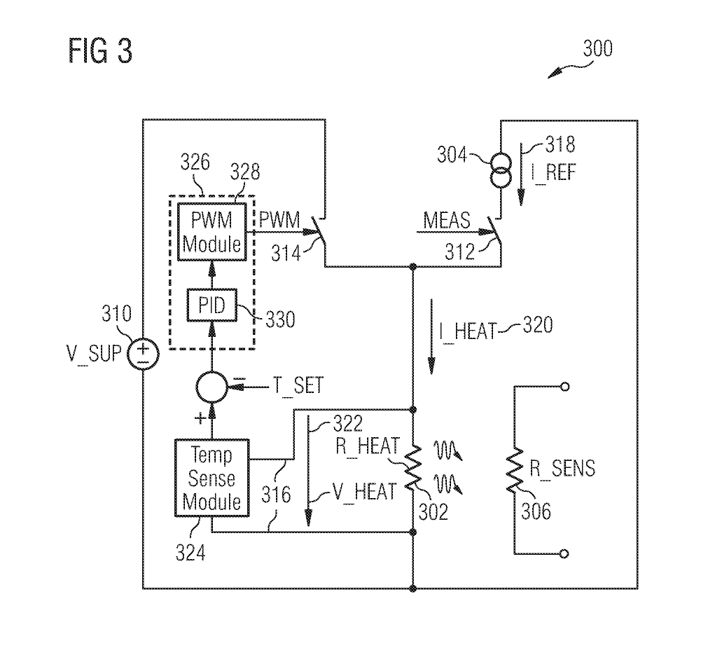

FIG. 3 is a circuit diagram illustrating a temperature sensing and control system 300 according using a controlled measurement current according to some embodiments. In some embodiments, a single heater 302 is employed, and the heater 302 is connected to a voltage source V_SUP 310 by a PWM switch PWM 314. The heater 302 is also connected to a current source 304 that provides a measurement signal I_REF 318 through a measurement switch MEAS 312. The system 300 separates the heating phase and the sensing phase for the heater 302 introduces a higher degree of freedom into the circuit design, desirable for system-in-a-chip integration. In some embodiments, a control circuit 326 is connected to the PWM switch PWM 314 and the measurement switch MEAS 312. In some embodiments, the control circuit 326 has, for example, a PWM module 328 and a PID loop 330.

The control circuit 326 coordinates the timing of the switches 312 and 314 so that the pulses in the PWM power signal and the measurement signal I_REF 318 do not overlap or interfere. Additionally, a voltage measurement circuit such as a temperature sensing module 324 may be connected to the terminals 316 to measure the heater voltage V_HEAT 316. The temperature of the heater 302 is sensed and compared to the target temperature T_SET 332. The temperature difference is filtered by the PID loop filter 330, which controls the duty cycle of the PWM module or controller 328. The heater 302 temperature will stably reach T_SET regardless of the ambient temperature since the actual temperature of the heater 302 is being compared against the target temperature T_SET. The PID filter 330 adjusts the heater 302 temperature according to varying ambient temperatures and will also track changes of the target temperature T_SET 332.

The temperature sensing module 324 measures the heater voltage V_HEAT 316, in some embodiments, with a 2-wire or the 4-wire method. The 4-wire method uses dedicated contacts or terminals 316 for voltage sensing directly at the heater 302. This excludes the additional voltage drops over the wires carrying the heater supply current from the measurement and may be used for low-ohmic heaters. In other embodiments such as the 2-wire method, the measurement of the heater voltage V_HEAT 316 may be taken directly at the heater 302.

The heater 302 heats the sensor R_SENS 306 when the PWM switch 314 is closed and the voltage source V_SUP 310 provides the PWM power signal to the heater 302. The heating phase and sensing phase are separated by applying a known reference current to the heater 302 when the power signal to the heater 302 is off. The PWM switch 314 and measurement switch 312 are connected to the heater 302 so that a single signal I_HEAT 320 is provided to the heater 302. The measurement switch 312 is closed, or on, during periods when the PWM switch 314 is off, or open. The I_HEAT signal 320 is therefore a combination of the PWM power signals from the voltage source V_SUP 310 and the measurement signal I_REF 318. In periods where the PWM switch 314 is closed, the voltage source V_SUP 310 provides the PWM power signal to the heater 302 and the heater 302 heats the sensor R_SENS 306. In the periods where the measurement switch 312 is closed, the measurement signal I_REF 318 is provided to the heater 212, and a heater voltage V_HEAT 322 is measured at terminals 316. From the heater voltage V_HEAT 322, the heater resistance R_HEAT can be calculated using the Ohm's law.

V_HEAT=R_HEAT*I_HEAT (Eq. 5)

When the heater resistance R_HEAT is known, the heater temperature can be calculated according to the known resistor behavior. For example, a polysilicon heater may exhibit a 12% change in resistance in response to a 100° C. temperature change. Equation 5, (above) can be used to calculate the resistance R_HEAT and the heater temperature T accordingly using equation 3 (above).

Separating the measurement current I_REF in the sensing phase from the voltage source 310 providing the normally much higher current in the heating phase avoids a loss of power and efficiency due to voltage drop over an inline current source. Additionally, separating the sensing phase and heating phase avoids a need for a calibrated high power current source, and permits a single current source to be used for multiple heater channels. In other embodiments, the heater resistance may be measured by applying a known reference voltage and measuring the heater current during the measurement phase.

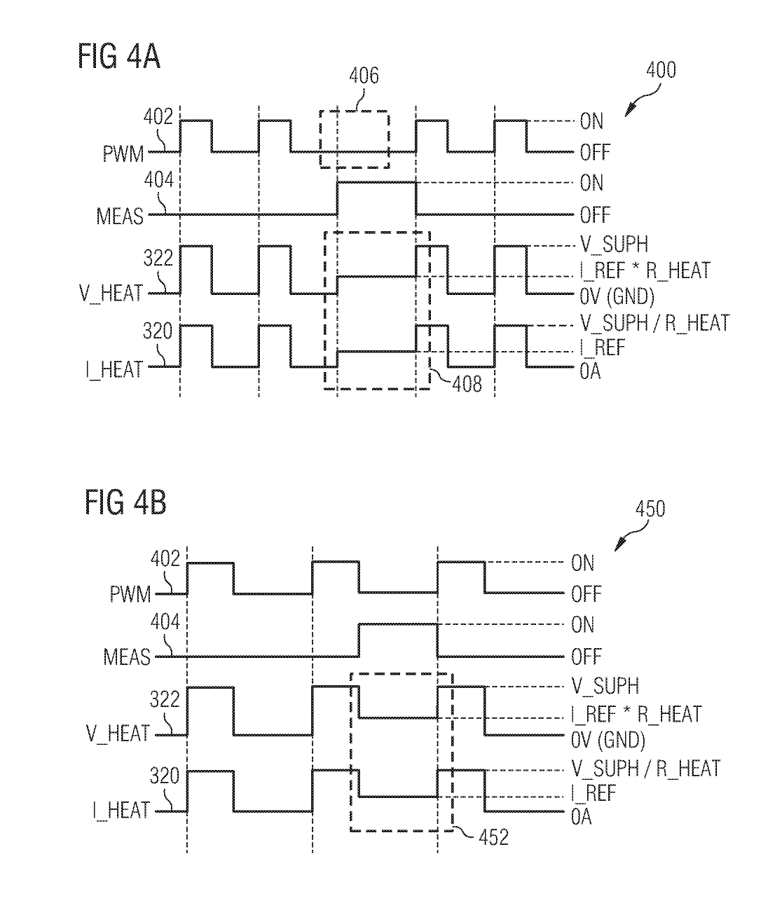

FIGS. 4A and 4B are graphs illustrating operating properties for a temperature sensing and control system using a controlled measurement current according to some embodiments. In some embodiments, the control circuit may cause the PWM switch to skip one or more pulses or cycles, and propagate the measurement current to the heater during skipped pulses. This may reduce the amount of energy transferred to the heater depending on how many PWM cycles are skipped, and permits the use of the full cycle for the PWM signal since no portion of the pulse cycle needs to be reserved for injection of the measurement signal.

FIG. 4A is a graph 400 illustrating operating properties for a temperature sensing and control system using a controlled measurement current in place of a skipped pulse according to some embodiments. In some embodiments, a control circuit may keep the PWM switch open so that the signal from the power source is not transmitted to the heater during a measurement stage. In an embodiment where one or more PWM pulses are skipped, the PWM power signal 402 has pulses that have a generally regular period, and a pulse in a measurement stage 406 is omitted. The control circuit then closes the measurement switch 312 during a portion of the measurement stage 406 so that the signal from the current source is provided to the heater as the measurement signal 404. The measurement signal 404 has a pulse that coincides with the measurement stage 406. In some embodiments, the measurement signal is injected to the heaters in place of an omitted PWM pulse. Thus the measurement signal pulse 404 overlaps a portion of a cycle in the PWM power signal where the omitted PWM pulse would normally occur. Therefore, when the measurement signal 404 is combined with the PWM power signal 402, a measurement pulse 408 is disposed between power signal pulses at the heater. The heater voltage V_HEAT 322 and I_HEAT 320 signals shown in the graph 400 show the measurement voltage and current at the heater during the measurement pulse 408. The voltage of the measurement pulse 408 at the heater varies with the resistance of the heater and the heater temperature, and therefore, will generally vary from the voltage of the power pulses of the heater voltage V_HEAT 322 that are created by the PWM power signal 402.

Providing the measurement signal separately from the PWM signal using a current source in parallel with the power supply avoids compromising heater power efficiency. This is because no additional voltage drops in the PWM switch path occur, such as in an a system where the current source or reference resistor is in series with the power supply. Additionally, the measurement current magnitude can be selected independently from that of the PWM signal current, resulting in less current than used for heating, and a voltage signal that is optimized for an analog to digital converter (ADC) voltage measurement input range. Therefore, the supply voltage of the temperature measurement portion of the system is independent from heater power portion of the system, which can be, for example, a noisy integrated circuit supply of a different circuit than the measurement current source. This allows the supply voltage circuit to be coarse and unregulated so that, for example, a battery voltage in mobile device can be used directly for the power supply. No additional voltage converters or regulators are required for the power supply since the more precise current source is regulated separately.

FIG. 4B is a graph 450 illustrating operating properties for a temperature sensing and control system using a controlled measurement current in place of a skipped pulse according to some embodiments. In some embodiments, the measurement current is inserted into the I_HEAT signal during off periods within the PWM cycle. Thus, the measurement pulse is disposed between pulses without overlapping the PWM pulses and without requiring that PWM pulses be skipped. The PWM power signal 402 maintains the regularity of the pulses created by the PWM switch without eliminating or skipping pulse in the PWM power signal 402, and the measurement signal 404 is generated with a pulse that falls between the PWM power signal 402 pulses. While this signal profile limits the usable duty cycle range, since some time has to be reserved for the measurement, the regularity of the power signal supplied to the heater is maintained since there is no need to remove one or more pulses from the power supply signal. In some embodiments, the maximum duty cycle of the PWM power signal 402 is about 75% of the overall PWM cycle, leaving 25% of the PWM cycle for the measurement pulse 452. In other embodiments, the duty cycle of the PWM power signal 402 is based on the settling time of the network or voltage measurement circuit, with the PWM adjusted to give the relevant circuit elements sufficient time to achieve a steady state so that an accurate heater voltage may be measured.

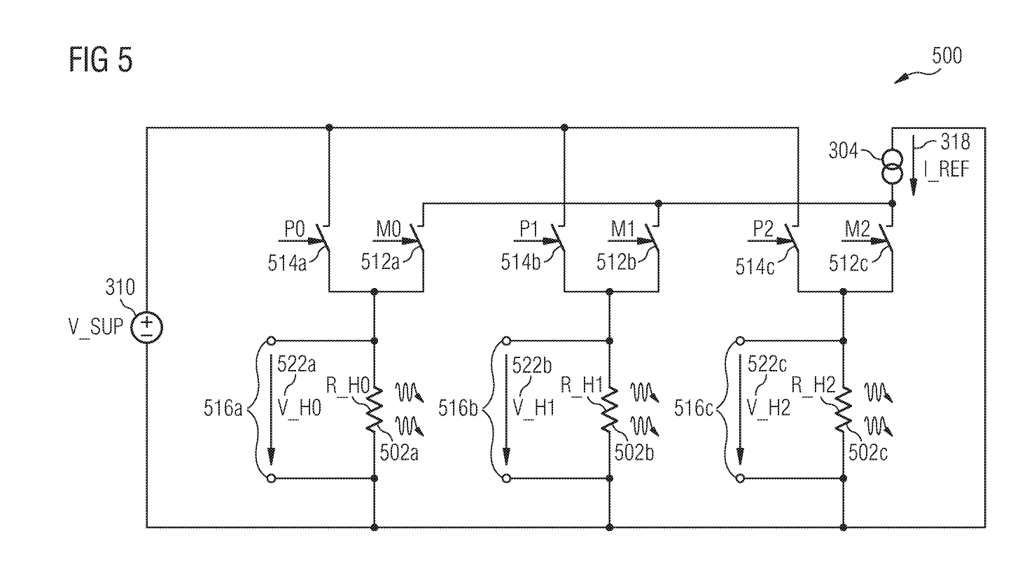

FIG. 5 is a circuit diagram illustrating a temperature sensing and control system 500 with multiple heaters 502a . . . 502c according to some embodiments. In this embodiment, a single current source 304 provides a measurement signal for each of the heaters 502a . . . 502c. In some embodiments, each heater 502a . . . 502c is associated with a PWM switch 514a . . . 514c and a measurement switch 512a . . . 512c. Each of the PWM switches 514a . . . 514c is disposed between a positive node of the voltage source 310 and a positive node of a respective heater 502a . . . 502c. Each of the measurement switches 512a . . . 512c is similarly disposed between a positive node of the current source 304 and the positive node of the respective heater 502a . . . 502c so that the measurement switches 512a . . . 512c block or allow the measurement signal I_REF 318 to flow from the current source 304 to the heaters 502a . . . 502c. Alternatively, the measurement switches 512a . . . 512c, PWM switches 514a . . . 514c, and current source may be on the ground side of the heaters 502a . . . 502c, with the heaters 502a . . . 502c directly connected to the voltage source 310. The control circuit controls the PWM switches 514a . . . 514c so that each heater 502a . . . 502c is individually controlled and receives an individualized power signal. Additionally, in some embodiments, the control circuit may control the measurement switches 512a . . . 512c so that each of the heaters 502a . . . 502c receives a measurement pulse from the current source 304 at a different time or during a different PWM cycle. Thus, the heater voltage 516a . . . 516c can be measured separately and individually so that the control circuit can determine the temperature of each heater 502a . . . 502c separately and adjust the duty cycle of the PWM signal to the respective heater 502a . . . 502c accordingly. Additionally, measuring each heater 502a . . . 502c individually prevents the heaters from acting as a parallel resistors and interfering with each other. However, in other embodiments, one or more heater voltages 516a . . . 516c may be measured during simultaneous measurement phases for multiple heaters 502a . . . 512c to determine an average temperature for the multiple measured heaters.

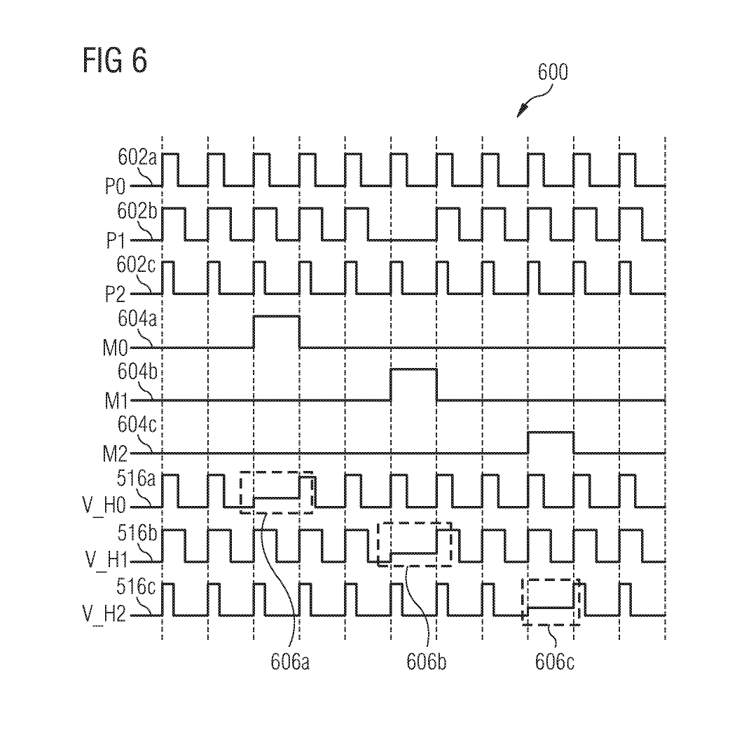

It should be understood that a system having multiple heaters may use a pulse in the measurement signal in place of one or more skipped PWM pulses, as shown above with respect to FIG. 4A, or may use a pulse that is between normal PWM pulses as shown above with respect to FIG. 4B. FIG. 6 is a graph 600 illustrating operating properties for a temperature sensing and control system with multiple heaters according to some embodiments. The graph 600 illustrates signals in a system where PWM pulses for each heater are skipped individually, and the measurement current can be inserted into the signal being transmitted to an individual heater in place of the heater power current.

Each PWM signal 602a . . . 602c may have a different PWM duty cycle and controls a respective PWM switch so that each respective heater has an individually controlled temperature. Each PWM signal 602a . . . 602c has a different measurement stage or cycle with a skipped PWM pulse. The measurement signals 604a . . . 604c each have a pulse that aligns with measurement stage of a different PWM signal 602a . . . 602c. The signals indicating the heater voltages 516a . . . 516c are each the sum of respective PSM signals 602a . . . 602c and the corresponding measurement signals 604a . . . 604c and have the PWM pulses with the measurement pulses 606a . . . 606c between PWM pulses.

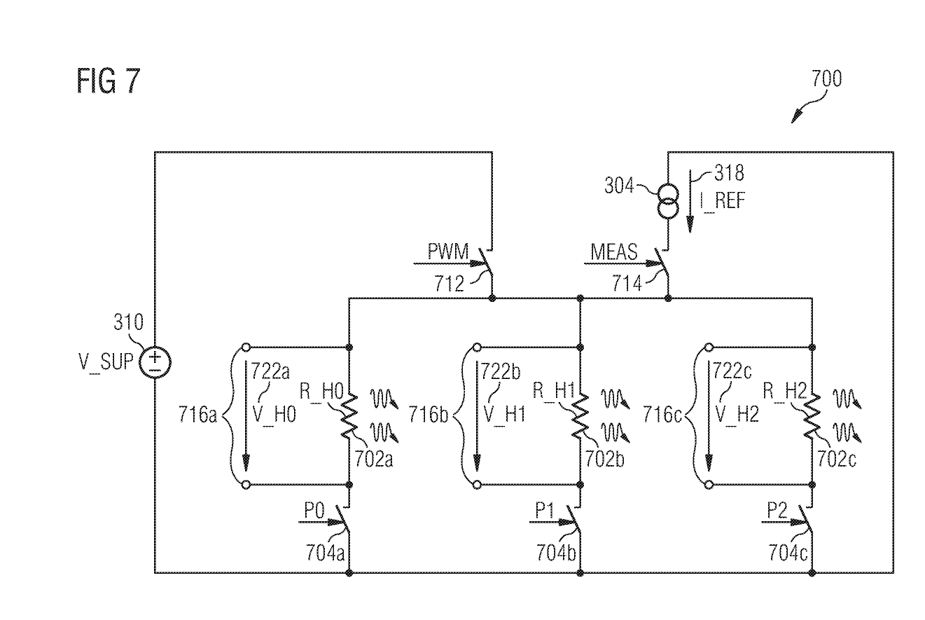

FIG. 7 is a circuit diagram illustrating a temperature sensing and control system 700 with multiple heaters 702a . . . 702c according to some embodiments. In some embodiments, access control switches 704a . . . 704c may each be associated with one of multiple heaters 702a . . . 702c. The access control switches 704a . . . 704c are each disposed between one or more of the heaters 702a . . . 702c and a common node or negative node of the voltage source 310 to control current flow through the heaters 702a . . . 702c. Such an arrangement reduces the overall amount of switches needed to provide individual pulses of the measurement signal I_REF 318 to respective heaters 702a . . . 702c. The PWM switch 712 controls the flow of power to all of the heaters 702a . . . 702c simultaneously during the heating phase, and the access control switches 704a . . . 704c control the duty cycle of the power signal through the respective heaters 702a . . . 702c. Similarly, the measurement switch 714 controls the measurement signal I_REF 318 to all of the heaters 702a . . . 702c simultaneously. During the measurement phase, the access control switches 704a . . . 704c cause the measurement signal I_REF 318 to be injected to the relevant heater 702a . . . 702c. Thus, the PWM switch 712 acts as a power enable switch for the power signal, and the measurement switch 714 acts as a measurement signal enable switch. The access control switches 704a . . . 704c may then close a circuit for individual heaters 702a . . . 702e so that a power signal or measurement signal passes through the particular heater 702a . . . 702c. In some embodiments, the control circuit controls the power signal or measurement signal through each individual heater 702a . . . 702c using the access control switches 704a . . . 704c.

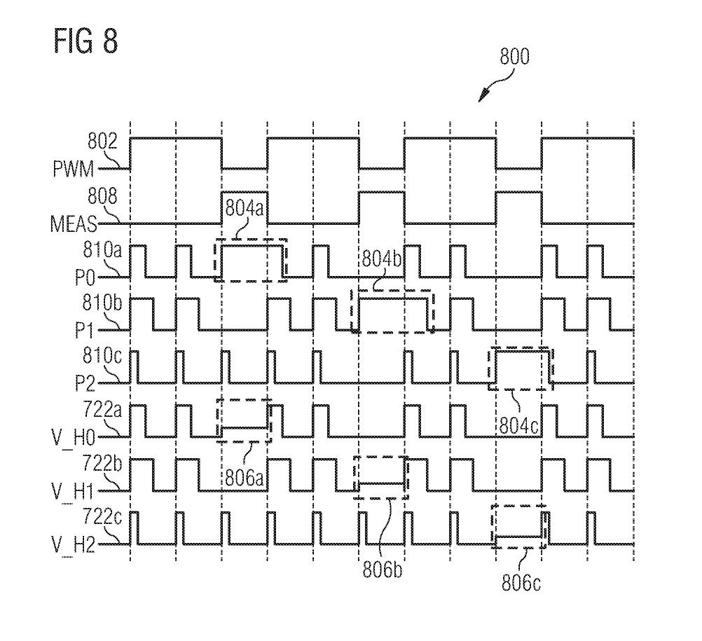

FIG. 8 is a graph 800 illustrating operating properties for a temperature sensing and control system with multiple heaters according to some embodiments. The PWM signal 802 is turned off for all heaters simultaneously during a measurement phase 804a . . . 804c of at least one of the heaters. The measurement signal 808 from the current source injects a pulse into the signal to each of the heaters. The access control switches control the heater signals 810a . . . 810c at each of the heaters, and control the PWM pulses and measurement pulse in response to control signalling from, for example, the control circuit. The heater signals 810a . . . 810c are a combination of the PWM signal and the measurement signal, as modified by the access control switches. Each of the heater signals 810a . . . 810c have PWM signal pulses that are omitted for each of the heaters. During this measurement phase the access control switches act as a multiplexer and select the heater channel to be measured. Such an arrangement provides a greater reduction on the number of switch elements with increasing numbers of heater channels. Each of the heater signals 810a . . . 810c also has a pulse from the measuring signal in the measurement phase 804a . . . 804c of the respective heater. The heater voltages 722a . . . 722c signals then have the measurement pulse 806a . . . 806c indicating the voltage at the respective heater disposed between pulses of the PWM power signal.

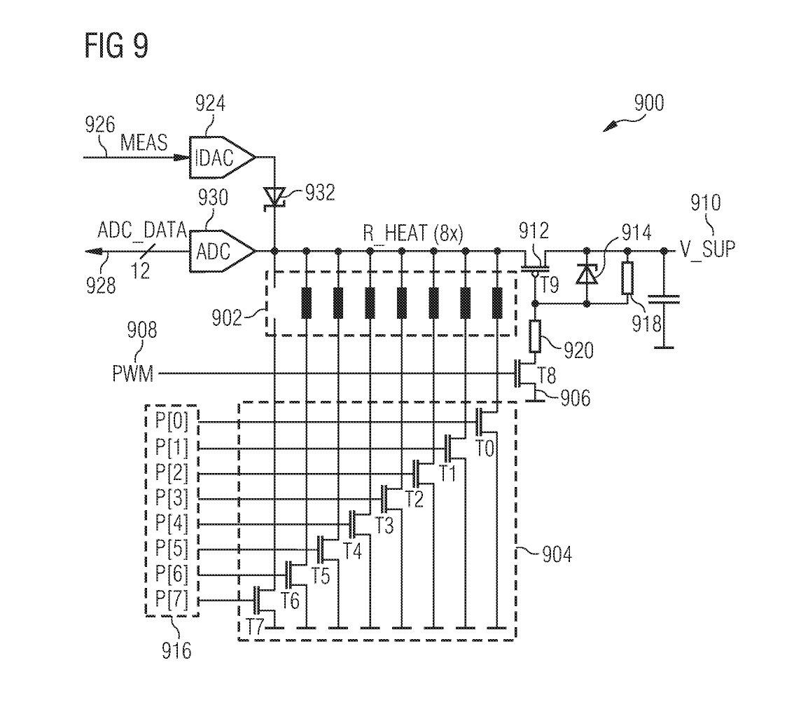

FIG. 9 is a circuit diagram illustrating a temperature sensing and control system 900 with multiple heaters 902 according to some embodiments. In some embodiments, the system 900 may implement the functionality described above with respect to FIGS. 7 and 8.

In some embodiments, the access control switches 904 are implemented with N-channel metal oxide semiconductor (N-MOS) transistors T0 . . . T7. The access control switches 904 are individually controlled by access control signals 916 from, for example, the control circuit. The PWM switch T9 912 supplies the PWM supply voltage V_SUP 910 from a voltage supply and is an N-channel metal oxide semiconductor (P-MOS) transistor. The PWM switch T9 912 is driven by the ground referenced signal using the N-MOS control transistor T8 906. The control transistor T8 906 is, in some embodiments, controlled by a signal from the control circuit. The gate voltage of the PWM switch T9 912 is constrained using resistors 918 and 920 and a Zener diode 914.

The reference current is generated by a digital to analog converter with current output (IDAC) 924. This current IDAC 924 is enabled by the MEAS signal 926 and decoupled from the potentially high voltage heater supply voltage V_SUP 910 by a diode 932. In some embodiments, the IDAC 924 acts as the measurement switch, controlling the measurement signal being provided to the heaters 902.

An analog to digital converter for voltage (ADC) 930 is used as a voltage measurement circuit to measure the voltage drop over the heaters 902. The voltage drop during the measurement cycle is used to determine the heater resistance, and ultimately the heater temperature. The ADC 930 may also be used to measure the heater supply voltage in normal PWM cycles. In some embodiment, the ADC 930 provides a digital measurement signal 928 to a voltage measurement circuit, or to the control circuit.

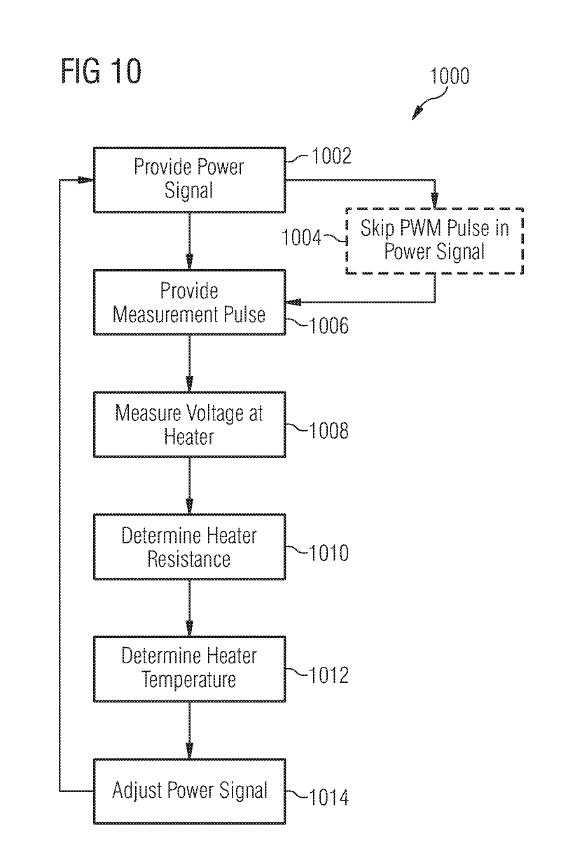

FIG. 10 is a flow diagram illustrating a method for temperature sensing and control according to some embodiments. In block 1002, a power signal is provided. In some embodiments, the power signal is controlled by a PWM switch in response to a signal from a control circuit, and generates a power signal with PWM pulses. The PWM pulses have a duty cycle that is controlled to regulate the power delivered to a heater, and to control the temperature of the heater. In some embodiments, a PWM pulse in the power signal is skipped in block 1004. The PWM pulse may be skipped by not opening a PWM switch or access control switch according to an instruction or control signal from the control circuit. The access control switches are used to select the heater though which the measurement current will flow, and keeping the PWM switch closed prevents the power signal and measurement current from simultaneously flowing through the heater selected by the access switches for measurement.

In block 1006, a measurement pulse is provided to the heater. In some embodiments, a measurement switch or access control switch electrically connects one or more heaters to a current source according to an instruction or control signal from the control circuit. In some embodiments, the measurement pulse is injected between PWM pulses that are in directly adjacent cycles in the power signal without skipping any PWM pulses. In other embodiments, the measurement pulse is injected in the cycle of a skipped PWM pulse in the power signal. In block 1008, the voltage across the heater is measured. In some embodiments, the voltage created by the measurement pulse is measured directly at the heater using a 2-wire system, or across terminals connected to the heater using a 4-wire system. The heater voltage is measured by a voltage measurement circuit, and the measurement may be performed in response to a control signal from the control circuit.

The heater resistance is determined in block 1010. In some embodiments, the heater resistance is determined from the heater voltage and form the known value of the current of the measurement pulse supplied by the current source. In block 1012, the heater temperature is determined. The heater temperature may be determined from the calculated resistance, and, in some embodiments, may be determined according to the calculated resistance, the temperature coefficient of the heater material, and the heater resistance at a reference temperature. In block 1014, the power signal is adjusted. In some embodiments, the control circuit receives or determines the heater temperature and adjusts the duty cycle of the PWM pulses in the power signal to the heaters. Additionally, in some embodiments, the process may be repeated one or more times so that temperature regulation is performed continuously.

An embodiment method includes providing a power signal to a heater, the power signal having pulse width modulated (PWM) power pulses, providing a measurement pulse to the heater, with the measurement pulse being between two PWM power pulses, measuring a voltage across the heater, and determining a resistance of the heater according to the voltage across the heater and a current of the measurement pulse. A temperature of the heater is determined according to the determined resistance of the heater.

In an embodiment, the method further includes adjusting the power signal according to the temperature of the heater. In an embodiment, the measurement pulse is a constant current measurement pulse provided by a current source. In an embodiment, the temperature is determined according to the determined resistance of the heater, a temperature coefficient of a material of the heater, and a resistance at a reference temperature of the heater. In an embodiment, providing the power signal to the heater includes providing the power signal to a heater with a first PWM cycle between the two PWM power pulses and during a skipped PWM power pulse, with at least a portion of the measurement pulse being provided to the heater in the first PWM cycle. In an embodiment, the two PWM power pulses are in immediately adjacent PWM cycles.

An embodiment device includes a signal switching circuit connected to the one or more heater ports, and the heater ports are configured to be connected, respectively, to one or more heaters. The device further includes a current source connected to the signal switching circuit, with the signal switching circuit disposed between the current source and the one or more heater ports. A control circuit is coupled to the signal switching circuit, and a voltage measurement circuit is configured to measure a first voltage across the one or more heater ports. The signal switching circuit is configured to control a first current from the current source to provide a measurement pulse to the one or more heater ports according to a second signal from the control circuit. The first voltage is created by the measurement pulse across the one or more heater ports, and the control circuit is configured to control the signal switching circuit according to a temperature determined according to the measured first voltage.

In an embodiment, the device further includes a power supply port connected to the signal switching circuit. The current source is connected in parallel with the power supply port to the signal switching circuit, and the signal switching circuit is further configured to control a third signal from the power supply port to provide a power signal having pulse width modulated (PWM) power pulses to the one or more heater ports according to a first signal from the control circuit. The control circuit is further configured to coordinate the PWM power pulses and the measurement pulse so that the measurement pulse is provided to the one or more heater ports between the PWM power pulses. In an embodiment, the control circuit is further configured to coordinate the PWM power pulses and the measurement pulse by skipping at least one of the PWM pulses and providing at least a portion of the measurement pulse to the one or more heater ports in at least a portion of a cycle of the skipped PWM pulse. In an embodiment, the control circuit is further configured to coordinate the PWM power pulses and the measurement pulse by providing at least the measurement pulse to the one or more heater ports between adjacent PWM pulses. In an embodiment, the control circuit is further configured to limit a maximum duty cycle of the PWM power pulses to 75% of an overall PWM cycle. In an embodiment, the device further includes a sensor and one or more heaters connected to the one or more heater ports, with the one or more heaters are configured to heat the sensor. In an embodiment, the device further includes two or more heaters connected to the one or more heater ports, and the signal switching circuit is configured to control the first current from the current source to provide a separate measurement pulse to each of the two or more heaters according to a fourth signal from the control circuit. The voltage measurement circuit is configured to separately measure voltages created by the separate measurement pulses across each of the two or more heaters.

An embodiment device includes a first heater, a first measurement switch having a first end connected to a first end of the first heater, a current source having a first end connected to a second end of the first measurement switch, a control circuit connected to the first measurement switch, and an analog to digital converter (ADC) having a first analog input end connected to the first end of the first heater and a digital output end connected to the control circuit.

In an embodiment, the current source and the measurement switch form a digital to analog converter with current output (IDAC), with the IDAC having an analog output connected to the first end of the first heater, and an input connected to the control circuit. In an embodiment, the device further includes a first pulse width modulation (PWM) transistor having a first channel port connected to the first end of the first heater, a second channel port connected to a power supply port, and a gate connected to the control circuit. In an embodiment, the device further includes a power supply connected to the power supply port, with the power supply connected in parallel with the IDAC to the first heater. In an embodiment, the device further includes a second heater, wherein the first analog end of the ADC is connected to a first end of the second heater. In an embodiment, the device further includes a first access control transistor connected between a second end of the first heater and ground, and further includes a second access control transistor connected between second end of the second heater and ground. Gates of the first access control transistor and the second access control transistor are connected to the control circuit. In an embodiment, the device further includes a second heater, a power supply, a first pulse width modulation (PWM) transistor having a first channel port connected to the first end of the first heater, a second channel port connected to the power supply, and a first gate connected to the control circuit; and a second PWM having a third channel port connected to a first end of the second heater, a fourth channel port connected to a power supply port, and a second gate connected to the control circuit.

While the above mentioned embodiments are described in terms of a heater element for a sensor, it should be understood that the embodiments are not limited to such systems. The heater temperature measurement systems described above may be implemented as a dedicated temperature sensor, a stand-alone heating element, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
providing a power signal to a heater, the power signal having pulse width modulated (PWM) power pulses;
providing a measurement pulse to the heater, wherein the measurement pulse is between two PWM power pulses;
measuring a voltage across the heater;
determining a resistance of the heater according to the voltage across the heater and a current of the measurement pulse; and
determining a temperature of the heater according to the determined resistance of the heater.

2. The method of claim 1, further comprising adjusting the power signal according to the temperature of the heater.

3. The method of claim 1, wherein the measurement pulse is a constant current measurement pulse provided by a current source.

4. The method of claim 1, wherein the temperature is determined according to the determined resistance of the heater, a temperature coefficient of a material of the heater, and a resistance at a reference temperature of the heater.

5. The method of claim 1, wherein providing the power signal to the heater comprises providing the power signal to a heater with a first PWM cycle between the two PWM power pulses and during a skipped PWM power pulse; and
wherein at least a portion of the measurement pulse is provided to the heater in the first PWM cycle.

6. The method of claim 1, wherein the two PWM power pulses are in immediately adjacent PWM cycles.

7. A device, comprising:
a signal switching circuit connected to the one or more heater ports, wherein the heater ports are configured to be connected, respectively, to one or more heaters;
a current source connected to the signal switching circuit, wherein the signal switching circuit is disposed between the current source and the one or more heater ports;
a control circuit coupled to the signal switching circuit;
a voltage measurement circuit configured to measure a first voltage across the one or more heater ports;
wherein the signal switching circuit is configured to control a first current from the current source to provide a measurement pulse to the one or more heater ports according to a second signal from the control circuit;
wherein the first voltage is created by the measurement pulse across the one or more heater ports; and
wherein the control circuit is configured to control the signal switching circuit according to a temperature determined according to the measured first voltage.

8. The device of claim 7, further comprising:
a power supply port connected to the signal switching circuit;
wherein the current source is connected in parallel with the power supply port to the signal switching circuit;
wherein the signal switching circuit is further configured to control a third signal from the power supply port to provide a power signal having pulse width modulated (PWM) power pulses to the one or more heater ports according to a first signal from the control circuit; and
wherein the control circuit is further configured to coordinate the PWM power pulses and the measurement pulse so that the measurement pulse is provided to the one or more heater ports between the PWM power pulses.

9. The device of claim 8, wherein the control circuit is further configured to coordinate the PWM power pulses and the measurement pulse by skipping at least one of the PWM pulses and providing at least a portion of the measurement pulse to the one or more heater ports in at least a portion of a cycle of the skipped PWM pulse.

10. The device of claim 8, wherein the control circuit is further configured to coordinate the PWM power pulses and the measurement pulse by providing at least the measurement pulse to the one or more heater ports between adjacent PWM pulses.

11. The device of claim 10, wherein the control circuit is further configured to limit a maximum duty cycle of the PWM power pulses to 75% of an overall PWM cycle.

12. The device of claim 8, further comprising a sensor, and one or more heaters connected to the one or more heater ports, wherein the one or more heaters are configured to heat the sensor.

13. The device of claim 7, further comprising two or more heaters connected to the one or more heater ports;
wherein the signal switching circuit is configured to control the first current from the current source to provide a separate measurement pulse to each of the two or more heaters according to a fourth signal from the control circuit; and
wherein the voltage measurement circuit is configured to separately measure voltages created by the separate measurement pulses across each of the two or more heaters.

14. A device, comprising:
a first heater;
a first measurement switch having a first end connected to a first end of the first heater;
a current source having a first end connected to a second end of the first measurement switch;
a control circuit connected to the first measurement switch; and
an analog to digital converter (ADC) having a first analog input end connected to the first end of the first heater and a digital output end connected to the control circuit.

15. The device of claim 14, wherein the current source and the measurement switch form a digital to analog converter with current output (IDAC), wherein the IDAC has an analog output connected to the first end of the first heater, and an input connected to the control circuit.

16. The device of claim 15, further comprising a first pulse width modulation (PWM) transistor having a first channel port connected to the first end of the first heater, a second channel port connected to a power supply port, and a gate connected to the control circuit.

17. The device of claim 16, further comprising a power supply connected to the power supply port, wherein the power supply is connected in parallel with the IDAC to the first heater.

18. The device of claim 14, further comprising a second heater, wherein the first analog end of the ADC is connected to a first end of the second heater.

19. The device of claim 18, further comprising a first access control transistor connected between a second end of the first heater and ground, and further comprising a second access control transistor connected between second end of the second heater and ground, wherein gates of the first access control transistor and the second access control transistor are connected to the control circuit.

20. The device of claim 14, further comprising:
a second heater;
a power supply;
a first pulse width modulation (PWM) transistor having a first channel port connected to the first end of the first heater, a second channel port connected to the power supply, and a first gate connected to the control circuit; and
a second PWM having a third channel port connected to a first end of the second heater, a fourth channel port connected to a power supply port, and a second gate connected to the control circuit.
